(19) United States
(12) Patent Application Publication
(10) Pub. No.: US 2024/0403702 A1
(43) Pub. Date: Dec. 5, 2024

(54) System and Method for Coordinating Resources in Multiplatform Environments Via Machine Learning

(71) Applicant: The Toronto-Dominion Bank, Toronto (CA)

(72) Inventor: Arash DELJAVAN FARSHI, Richmond Hill (CA)

(73) Assignee: The Toronto-Dominion Bank, Toronto (CA)

(21) Appl. No.: 18/329,210

(22) Filed: Jun. 5, 2023

(51) Int. Cl. G06N 20/00; H04L 51/02

(52) U.S. Cl. CPC G06N 20/00; H04L 51/02

(57) ABSTRACT

A system and method are provided for coordinating resources in multiplatform environments. The illustrative method includes providing a first platform to receive a first query for determining one or more properties of a process of a second platform of an enterprise. The method includes selecting a machine learning model from a plurality of machine learning models based on the first query, and generating a second query, based on the first query, for a selected machine learning model associated with the process. The second query is provided to the selected machine learning model. The selected machine learning model searches the second platform to determine properties, having been trained on queries from intermediate platforms. The selected machine learning model outputs one or more determined properties in response to the second query. The one or more determined properties are served as a response to the first query.

### TECHNICAL FIELD

The following relates generally to multi-platform systems, and in particular to coordinating between multi-platform systems using machine learning models.

### BACKGROUND

Existing digital infrastructure, particularly in large institutions, can be complex and may include different silos, built over time and potentially independent of one another, interacting with one another to execute and advance workflows.

Maintaining these disparate systems or platforms can be expensive and, over time, can become increasingly more complicated. Moreover, controlling coordination between these disparate platforms to, for example, increase accuracy, provide faster querying, etc., is challenging given their complexity and development history. These challenges can become particularly acute when the interaction between the platforms includes coordination with platforms that interact with customers to provide services.

Additionally, in service-related businesses, not only may it be difficult to coordinate between the different siloed platforms, but it can also be difficult to generate platforms that enable a customer to navigate the siloed platforms. Poor customer navigation of the platforms, and related guidance systems, can unnecessarily increase the expense and/or resources associated with satisfying the customer requests. The poor customer navigation can also lead to the need to create parallel platforms for navigation, increasing the amount of unnecessary expense and/or resource allocations to navigate platforms as compared to performing the underlying functionality.

Problems associated with coordinating different platforms is likely to increase over time, as updating the platforms becomes increasingly complex with additional platform interaction, and on account of servicing and changes that can make coordination more complicated, or updating more frequent, etc.

Implementing and maintaining systems to coordinate between platforms in a robust, scalable, efficient, manageable, adaptable, resource friendly (e.g., expertise, cloud computing requirements, etc.), relatively inexpensive manner is desirable.

### BRIEF DESCRIPTION OF THE DRAWINGS

Embodiments will now be described with reference to the appended drawings wherein:

FIG. 1 is a schematic diagram of an example computing environment.

FIG. 2 a block diagram of an example process for coordinating resources in multiplatform environment.

FIG. 3 is a block diagram of an example configuration of a platform.

FIG. 4 is a block diagram of an example configuration of an enterprise system.

FIG. 5 is a block diagram of an example configuration of a computing device associated with a user, customer, or client.

FIG. 6 is a flow diagram of an example of computer executable instructions for coordinating resources in multiplatform environment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It is understood that the use of the term “data file,” also referred to as a “data element” is not intended to be limited solely to individual data files, and that an expansive definition of the term is intended unless specified otherwise. For example, the data file can store information in different formats, can be stored on different media (e.g., a database, a portable data stick, etc.). The data file may not necessarily be an independent file, and can be part of a data file, or include a routine, method, object, etc.

This disclosure relates to an intermediary automated system (e.g., a bot, a machine learning powered bot, etc.) and a plurality of machine learning modules configured to interact with back-end systems, such as an event handler, to respond to requests from front-end systems (e.g., queries from customers). Each of the plurality of machine learning modules can be trained to be limited in scope to a particular platform, subsystem, or division of an enterprise. The use of a plurality of machine learning modules, and an intermediary automated system can in part avoid the technical challenges associated with building a machine learning model that can handle too much, or that is too expensive to run, or a model being so large and serving so much functionality such that it is required to run on hardware that is unavailable in a variety of different use cases.

The example of a credit card is illustrative, wherein a query from a customer related to a credit card application is received. The intermediary bot can determine the machine learning model(s) to use to satisfy the query, and generates what it believes to be an effective query for the determined machine learning models. The models themselves are trained to search or otherwise interact with back-end systems, or a proxy for same (e.g., and event handler like Kafka).

In the provided example, overuse of the back-end system can be avoided through automated querying of intermediate systems (e.g., the event handler), the back end employee can be spared from many lower level tasks, the amount of time required to service a query can be reduced, etc. The time-consuming customer engagement to determine inputs such as financial information, credentials, document signing, option selections, etc., that can be involved when back and front-end employees are required to communicate is relieved.

In one aspect, there is provided a device for coordinating resources in multiplatform environments. The device includes a processor, a communications module coupled to the processor, and a memory coupled to the processor. The memory stores computer executable instructions that when executed by the processor cause the processor to provide a first platform to receive a first query, the first query for determining one or more properties of a process of a second platform of an enterprise. The instructions cause the processor to select a machine learning model from a plurality of machine learning models based on the first query. The selected machine learning model is associated with the second platform that interfaces with the process. The instructions cause the processor to generate a second query, based on the first query, for the selected machine learning model. The instructions cause the processor to use the second query and the selected machine learning model to determine and output one or more properties of the process, having been trained based on queries to intermediary platforms. The selected machine learning model outputs one or more determined properties in response to receiving the second query. The instructions cause the processor to serve, via the first platform, the one or more determined properties as a response to the first query.

In example embodiments, the first query is provided by a user, and the intermediary platform is an automated platform for generating second queries from the user input first query.

In example embodiments, each of a first group of machine learning models of the plurality of machine learning modes are trained to determine properties of different platforms.

In example embodiments, the second platform is an event handler that manages a plurality of processes for a plurality of platforms. The selected machine learning model can be trained to identify properties from the plurality of processes maintained by an event handler.

In example embodiments, the instructions cause the processor to retrain the selected machine learning model based on updating training data for the second platform. The instructions can cause the processor to retrain another machine learning model of the plurality of machine learning models based on updating training data for another related platform.

In example embodiments, the first platform includes a telephonic channel or a computer-based channel for receiving input from customers or employees. The computer-based channel can be a chatbot.

In example embodiments, the selected machine learning model is trained with reference data representing workflows of the second platform.

In another aspect, a method for coordinating resources in multiplatform environments is disclosed. The method is executed by a device having a communications module and a processor and includes providing a first platform to receive a first query. The first query can be for determining one or more properties of a process of a second platform of an enterprise. The method includes selecting a machine learning model of a plurality of machine learning models based on the first query. The selected machine learning model is associated with the second platform that interfaces with the process. The method includes generating a second query, based on the first query, for the selected machine learning model. The method includes using the second query and the selected machine learning model to search the second platform to determine properties of the process and to output one or more determined properties. The selected machine learning model is trained based on queries from intermediary platforms. The selected machine learning model outputs one or more determined properties in response to the second query. The method includes serving, via the first platform, the one or more determined properties as a response to the first query.

In example embodiments, the first query is provided by a user, and the intermediary platform is an automated platform for generating second queries from the user input first query.

In example embodiments, each of a first group of machine learning models of the plurality of machine learning modes are trained to determine properties of different platforms.

In example embodiments, the second platform is an event handler that manages a plurality of processes for a plurality of platforms. The selected machine learning model can be trained to identify properties from the plurality of processes maintained by an event handler.

In example embodiments, the method includes retraining the selected machine learning model based on updating training data for the second platform. The method can include retraining another machine learning model of the plurality of machine learning models based on updating training data for another related platform.

In example embodiments, the first platform includes a telephonic channel or a computer-based channel for receiving input from customers or employees. The computer-based channel can be a chatbot.

In example embodiments, the selected machine learning model is trained with reference data representing workflows of the second platform.

In another aspect, a non-transitory computer readable medium for coordinating resources in multiplatform environments is disclosed. The computer readable medium includes computer executable instructions for performing the above recited method aspect.

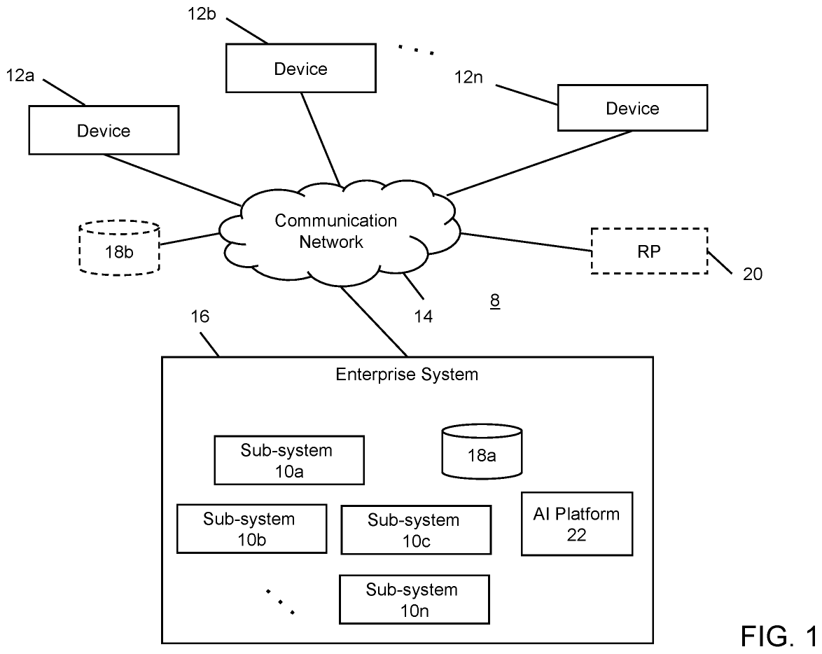

Referring now to the figures, FIG. 1 illustrates an example computing environment 8. The computing environment 8, as shown, includes one or more devices 12, a source of data elements, such as the shown datastore 18, (optionally) a remote platform 20 (hereinafter referred to in the singular for ease of reference), an enterprise system 16, and a communications network 14 connecting one or more components of the computing environment 8.

The enterprise system 16 (e.g., a financial institution such as commercial bank and/or insurance provider) can be for providing services to users (e.g., processes financial transactions). The services generate, cause the enterprise system 16 to come into possession of, or are responsible for the storage of data elements. The data elements or related processes can be stored within enterprise system-operated databases, such as the shown databases 18a, or on a platform 10, etc. Similarly, the data elements or related processes can be stored in devices 12 controlled by the enterprise system 16, or stored in devices remote to the enterprise system 16 but with access thereto, such as the shown devices 12a, 12b, to 12n, or the remote database 18b. The data elements can be stored on systems remote to the system 16, such as the remote platform 20.

It is understood that while the enterprise system 16 and the remote platform 20 are shown as separate entities, they can be integrated at least in part (e.g., the remote platform 20 can be a cloud computing provider used to perform functionality of the enterprise system 16). Similarly, it is understood that the platforms 10 can be at least in part integrated. For example, at least some of the platforms 10 can be implemented on common hardware (e.g., servers). In example embodiments, at least some of the functions of the enterprise system 16 can be performed on a combination of the enterprise system 16, the remote platforms 20, and/or the device 12.

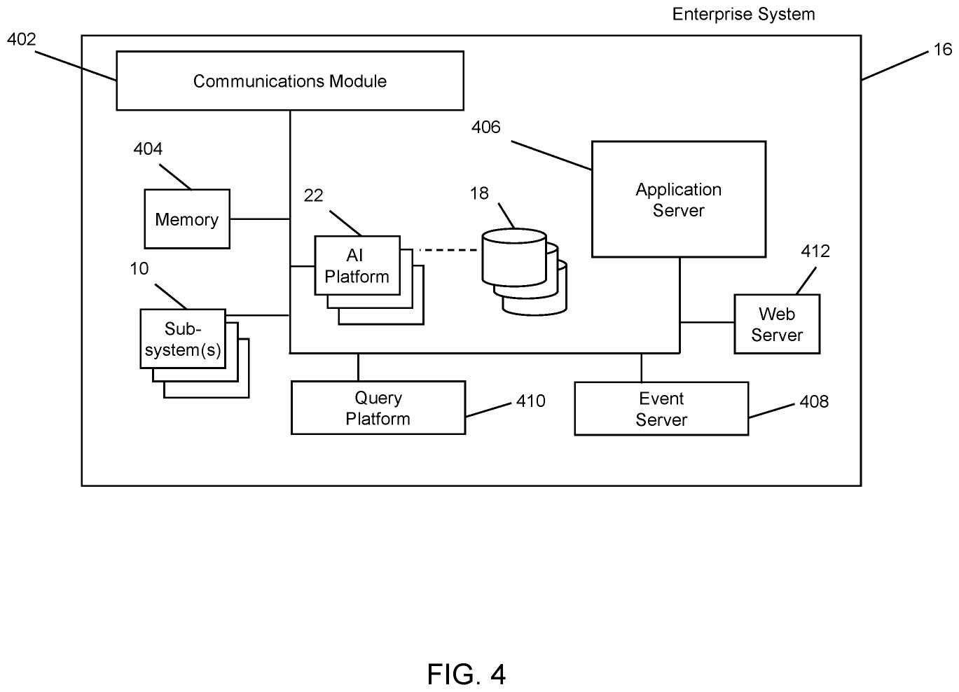

The enterprise system 16 can include different components, which components have been omitted from FIG. 1 for clarity. Some of the potential components are discussed in FIG. 4, below, with additional detail.

The enterprise system 16 can include a plurality of platforms 10 (shown as platforms 10a, 10b, 10c . . . 10n), and an artificial intelligence platform 22. The plurality of platforms 10 and/or the artificial intelligence platform 22 can be computer systems configured to process and store information and execute software instructions to perform one or more processes consistent with the disclosed embodiments.

The platforms 10 can have access to various different data or tools. Each platform 10 can be a standalone platform (not shown), a third-party platform used by the enterprise system 16, or a process or program embedded in other applications that interact with the enterprise system 16, etc. For example, the platforms 10 can have access to the remote platforms 20, to retrieve tools, data, criteria, credentials, templates, etc., used to perform the services related to the platform 10. For example, the platform 10 can access the remote platform 20 to store data elements and related applications to perform some functionality, and thereafter retrieve and require the stored data elements for use in response to a query. The platform 10 can require an attestation from an authentication platform in order to be able to access the relevant data elements.

The plurality of platforms 10 can be computer systems configured to perform one or more functions or services provided by the enterprise system 16. For example, the plurality of platforms 10 can include a platform for credit card applications, payment processing, etc., a platform for mortgage related activities, a platform for banking, a platform for mobile applications, a platform for financial instrument trading, a platform for managing inventory, a platform for receiving customer orders, etc. For clarity, neither the enterprise system 16, nor the platforms 10 are intended to be limited to a particular industry or service.

The plurality of platforms 10 can coordinate with one another based on one or more hierarchies. For example, in the embodiment shown in FIG. 1, platform 10a can be a front end or customer facing platform, platform 10b can be an intermediate platform, such as an authentication platform, platform 10c can be an event driven intermediate platform (e.g., an enterprise-wide event handler for tracking updates from various backend platforms), and the platform 10n represents backend systems. The term hierarchy, as used herein, can be used to denote a distance from the customer facing platform. For example, the platform 10a in the shown embodiment can be described as higher up in the hierarchy (i.e., closer to the customer), whereas the back-end platform 10n can be described as lower in the hierarchy (i.e., further from direct customer interaction). The hierarchy can be implemented for data security, governance, or other reasons by the enterprise system 16, and introduces one or more limitations of what services can be performed, what data can be accessed by which platform, etc. For example, the customer facing platform 10a in the shown embodiment can be prevented from making changes to reference customer records directly and require coordination with the back-end platform 10n in order to implement same.

The event handler platform 10 can be an enterprise system 16 wide implementation for tracking processes. That is, different platforms of the enterprise system 16 can be configured to provide event objects to the handler platform 10 (or notify the handler platform 10). The event objects can be based on one or more pre-defined processes. For example, a credit card application process implemented by a platform 10 can include various event objects, such as an application received object, a related third-party information retrieved object, an initial review object, an approved object, etc. Each of the event objects, or the overall process to which objects relate, can include one or more properties. Continuing with the credit card application example, an application received object can include a property related to when the application was received, by whom it was received; the initial review object can similarly include properties describing when the review was performed, who the review was performed by, but the next event in the process is, etc.

The platforms 10 can be stored on the enterprise system 16, or at least in part stored on a remote platform (such as the shown remote platform 20, which can be a cloud computing platform), or some combination of the two. Coordinating between platforms 10 stored on different platforms (e.g., one platform 10 is locally stored, while another is implemented on a remote platform) can exacerbate difficulties with coordinating multilevel platforms. For example, too many requests for back-end systems implemented on local hardware can introduce unacceptable delays or require resources to mitigate the volume of requests, unacceptably. In addition, the greater the ability to access disparate sub-platforms to answer queries, the greater the potential requirement to allocate resources to deal with variation in request volumes.

The artificial intelligence platform 22 includes a plurality of machine learning models. Each of the different machine learning models can be trained to identify properties from different platforms 10. For example, a first machine learning model can be configured to search, extract, write to, or otherwise interact with the platform 10 which manages credit card applications. Similarly, a second machine learning model can be configured to interact with a platform for mortgage applications. The machine learning models can be trained to identify properties based on prior interactions with the related platforms, queries to the enterprise system 16, one or more workflows or processes developed by the related platform (e.g., the machine learning model is taught in part with business or software workflows that are implemented on the relevant platform 10), based on fictitious examples, based on organizational charts (e.g., to identify responsible individuals), templates (e.g., commonly used documents are provided to the model for scanning and extraction), etc. For example, when a related platform 10 is updated, the related machine learning model may be retrained from scratch to account for new properties introduced by the update to the related platform 10.

The artificial intelligence platform 22 can include a plurality of different machine learning models for each particular platform 10, each of the models being responsive to different aspects of the platform 10. For example, the artificial intelligence platform 22 can have a plurality of different models for a credit card platform 10, with different models for different jurisdictions, languages, credit cards (e.g., a different machine learning model for each brand of credit card, as different credit cards can have different structures for benefits, entitlements, etc.). In at least some example embodiments, at least some of the different machine learning models can be used in a chained format. For example, the first machine learning model can be used to determine the status of the credit card application for particular brand of credit card, and operation of the status discerning machine learning model can also automatically trigger a machine learning model to determine potential entitlements based on spending history known to the enterprise system 16.

The plurality of machine learning models can be trained to identify properties from records stored in back-end platforms or based on events managed by an event handler platform 10 (e.g., an intermediary platform). For example, to avoid the expense and resources associated with frequent request to back-end platforms, the machine learning model can be trained to identify properties from events associated with the relevant backend platforms 10. That is, the machine learning model can be trained to search for the existence of a particular event, to identify the relevant property from an event, to identify the relevant process or properties based on event records, etc. In this way, the machine learning model can be trained to interact with the intermediate platform 10, avoiding generating traffic to the back-end platforms 10.

At least one of the plurality of machine learning models can be a machine learning model to generate queries for the other platform specific machine learning models (hereinafter referred to as the “querying machine learning model”). For example, a querying machine learning model can be trained with examples of predicted customer queries and queries that can successfully be ingested by the platform specific machine learning models. Again referring to the credit card application example, the querying machine learning model can, in response to user input in a chatbot asking for status of an application, traverse the chatbot chat history to identify access credentials, related authenticating information, information that can identify products or services managed by the enterprise system 16 (e.g., the querying machine learning model can be trained to identify earlier conversations about a bank account, which can be used to search for the related credit card application), and populate a query for the machine learning model associated with a credit card platform 10. In example embodiments, the querying machine learning model and the platform specific machine learning models are trained at the same time (e.g., an initial training), such that the querying machine learning model learns an effective output format for the query.

Each of the plurality of machine learning models in the artificial intelligence platform 22 can be self-contained. For example, a machine learning model related to a credit card application platform 10 can be configured to only interact with the credit card application platform 10. The self-containment can beneficially enable modular development, enabling updating or training (e.g., retraining) of the machine learning models without disrupting the performance of the enterprise system 16 as a whole. Relatedly, this self-containment can more quickly adapt to changes to the underlying platforms, provide more accurate outputs as a result limiting the training to particular instances, etc. The self-contained nature of the different machine learning models can also reduce the amount of complexity within the system. Machine learning models are notoriously difficult to explain, and focusing on a plurality of machine learning models not only reduces the amount of training time but reduces the amount of uncertainty as to the operations performed by the trained machine learning model (e.g., smaller machine learning models make it easier to identify bias which is been trained into the model).

The datastore 18 (referred to generally for ease of reference) stores the data elements and related processes, e.g., for an event handler platform. The data elements and related processes can include team, intranet, messaging, committee, or other client- or relationship-based data. The data elements and related processes can be data that is not controlled by certain processes within an enterprise system 16, or otherwise (e.g., enterprise system 16 generated data). For example, the data elements and related processes can include information about a third party application (relative to enterprise system 16) used by employees, such as human resources, information technology (IT), payroll, finance, or other specific application. The data elements and related processes in the datastore 18 may include data associated with a user of a device 12 that interacts with the enterprise system 16 (e.g., an employee, or other user associated with an organization associated with the enterprise system 16, or a customer, etc.). The data elements and related processes can include customer data associated with a device 12, and can include, for example, and without limitation, financial data, transactional data, personally identifiable information, data related to personal identification, demographic data (e.g., age, gender, income, location, etc.), preference data input by the client, and inferred data generated through machine learning, modeling, pattern matching, or other automated techniques. In at least one example embodiment, the data elements and related processes includes any data provided to a financial institution which is intended to be confidential, whether the data is provided by a client, employee, contractor, regulator, etc. The data elements and related processes in the datastore 18 may include historical interactions and transactions associated with the platforms 10 and/or enterprise system 16, e.g., login history, search history, communication logs, documents, etc.

Client device 12 may be associated with one or more users. Users may be referred to herein as employees, customers, clients, consumers, correspondents, or other entities that interact with the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with the enterprise system 16 via mobile or web-based applications provided by the enterprise system 16. In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12, enterprise system(s) 16, and/or remote platform(s) 20. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

The platforms 10, and/or enterprise system 16, and/or AI platform 22 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the platforms 10 and/or enterprise system 16. The cryptographic server may be used to protect, for example, the datastore 18 and/or the datafile on which security is being performed, etc., by way of encryption for data protection, digital signatures or message digests for data integrity, and by using digital certificates to authenticate the identity of the users and client devices 12 with which the enterprise system 16 and/or platforms 10 communicates to inhibit data breaches by adversaries. It can be appreciated that various cryptographic mechanisms and protocols can be chosen and implemented to suit the constraints and requirements of the particular deployment of the platforms 10 or enterprise system 16 as is known in the art.

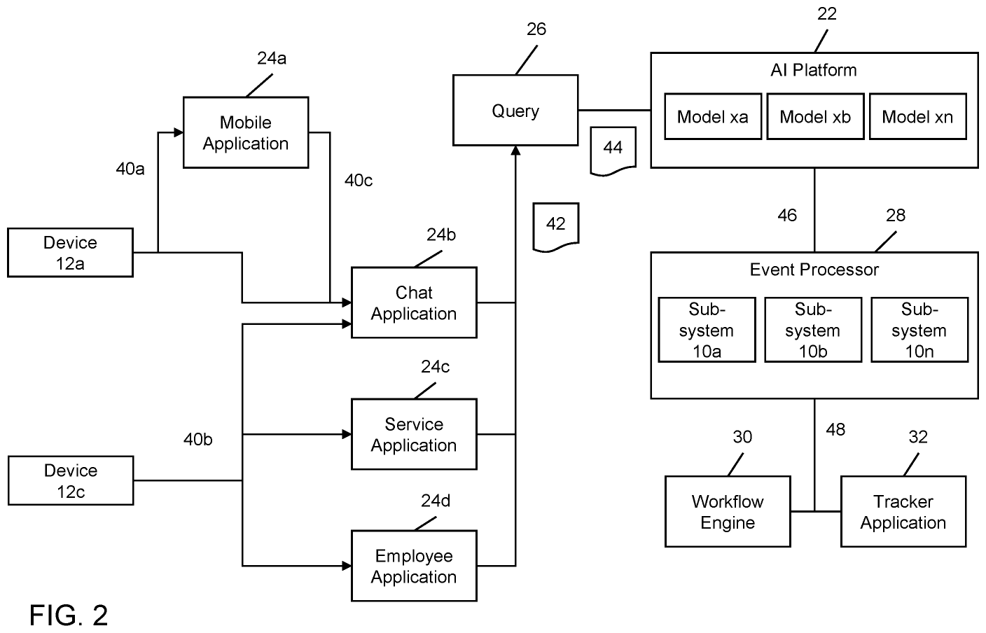

Referring now to FIG. 2, a block diagram of an example of coordinating resources in multiplatform environment is shown.

An example event handler platform 28 is shown, which event handler platform 28 receives event objects from workflow engines 30 (e.g., defining event objects, event properties, etc.) for each of the plurality of platforms (not shown in FIG. 2). The event handler platform 28 also receives one or more event objects from a tracker application 32. It is understood that the workflow engine 30 and the tracker application 32 are illustrative, and that different platforms 10, or more generally different components of the enterprise system 16. can have different means, or a variety of different means for generating event objects and related process structures.

At block 40, one or more front-end related applications 24 receive a first query from a device 12. In the example shown in block 40a, a customer device 12a is used to receive a first query into a mobile application 24a, or a chat application 24b. Optionally, shown as block 40c, the mobile application can be integrated with the chat application 24b, such that queries from the user device 12a are funneled to a common application to provide the querying machine learning model 26 with additional context. Block 40b shows interactions between an employee device 12c and the chat application 24b, or one or more service specific applications (e.g., service application 24c, which can be a computer-based channel, or employee application 24d, which can support employees that engage with customers via telephone, etc.). The employee device 12c can be credentialed to access a particular platform or partition thereof (e.g., a wealth management advisor), and use the related application (application 24d) to which their credentials enable access in order to provide services.

In example embodiments, customer interactions can automatically be routed to an employee device 12c, without a request from the customer device 12a. For example, if the chat application 24b determines that the user is requesting a status, an employee device 12c can be scheduled to interact with the customer to enhance customer service or query accuracy (e.g., the querying model 26 detects a query, and determines it is poorly composed). For example, the device 12a chat can flow to chat application 24b, and the information can trigger the employee device 12c being connected to the chat in the chat application 24b, where the employee device 12c can generate different queries or more accurate queries based on the conversations in the chat application 24b (e.g., via the service application 24c). In example embodiments, the employee device 12c is engaged in response to the querying machine learning model 26 or the AI platform 22 indicating that there is a low level of confidence in the response to the query 44 (as described herein).

The front-end platform applications 24 provide a query 42 to the querying machine learning model 26. In the shown embodiment, the querying machine learning model 26 is shown as a standalone model; it can be part of another application, or the artificial intelligence platform 22 (hereinafter referred to in the alternative as an AI platform), or the enterprise system 16, etc.

The query 42 can include raw data describing interaction between the device 12 and the relevant application 24. For example, the query 42 can include the time the query was initiated, the channel used to initiate the query (e.g., application 24b or 24a), the credentials used to access the application 24, any enter text or spoken words, etc. The query 42 can also include data derived from the interactions between the device 12 and the application 24. For example, in response to a user device 12 authenticating with the mobile application 24a, the application 24a can be configured to include in the query 42 any necessary credentialing information, information about the user of the device 12 that is related to the entered information (e.g., links to, or descriptions of related bank accounts, transaction history, etc.).

The querying machine learning model 26 ingests the first query 42 and determines the machine learning model from the artificial intelligence platform 22 that is relevant to the query 42. In example embodiments, the querying machine learning model 26 is at least in part automated and performs the determination as soon as a query (e.g., query 42) is received or determined. As described above, the querying machine learning model 26 can be trained with examples of prior interactions between the enterprise system 16 and the different models of the AI platform 22, based on fictitious examples, etc. To provide another example, the querying machine learning model 26 can determine, based on a user device 12 interaction with the chat application 24a asking for the status of an application, that certain of the models in the AI platform 22 relate to applications (e.g., a financial trading platform 10 does not have any application workflows), that the source of the query 42 is located in a particular jurisdiction (e.g., models related to other jurisdictions are excluded), that the credentials enable the user generating the query 42 to access certain of the models (e.g., the particular mobile application 24a is a banking application, and not a related trading application), etc. The model 26 can determine that there are candidate machine learning models x (shown as machine learning models xa, xb . . . xn). The context provided in the chat application 24a can further lead the querying machine learning model 26 to conclude that the query 42 relates to the credit card platform 10.

In example embodiments, the querying machine learning model 26 can query multiple ones of the machine learning models of the artificial intelligence platform 22. For example, the querying machine learning model 26 can be configured with a confidence threshold for the determined machine learning model, and if multiple models satisfy the threshold, the querying machine learning model 26 can query satisfactory models x. Continuing the example, the querying machine learning model 26 can query both the model associated with credit card applications, and the model associated with mortgage applications to determine whether an application event is present. In response to determining that the event handler platform 28 includes events associated with a credit card application being open, the querying machine learning model 26 can return output describing the properties associated with the credit card application.

The querying machine learning model 26 generates a second query 44 to provide the determined machine learning model. The second query 44 can be formatted as learned by the querying machine learning model 26 during training. In example embodiments the second query 44 can be populated with additional data including, access credentials, timing data, etc. The format of the query 44 can also be configured or pre-programmed, to account for changes in the machine learning models.

In example embodiments, the machine learning model 26 is not a machine learning model, but a bot pre-programmed to generate queries 42, where the pre-programming generates a fixed number of queries 44 independent of the nature of queries 42.

The machine learning models x in the AI platform 22 are trained to search, or otherwise interact with the event handler platform 28 (or the underlying back-end platforms 10) to determine one or more properties responsive to the query 44. Similarly, the machine learning models x output properties in a format learned as a result of their training. For example, the training material provided can teach the machine learning model x to automatically mask certain sensitive data (e.g., the first 10 digits of an application number), the format of the output (e.g., conversational, tabular, etc.), the number of properties included in the output (e.g., the individual, if any, responsible for a review phase of the event, the next steps in the event, etc.), and so forth. In example embodiments, the machine learning models x output is further passed through a bot to standardize the responses. E.g., the machine learning model x output can be used to populate a response template.

In this way, in at least some embodiments, the machine learning models x enable servicing of queries received from customers (directly, via device 12a, or indirectly, the device 12b) without generating unnecessary needless volume for the back-end platforms 10. Instead, the intermediate event handler platform 28 is queried. In addition, this proposed configuration can result in greater control of disclosure of sensitive information, as the machine learning models x can be trained to automatically redact sensitive information. In at least one example embodiment, a separate machine learning model (e.g., model xn) is trained to parse any outputs of the other machine learning models x and redact sensitive information. The querying machine learning model 26 can also enable more accurate navigation of the various platforms 10 for the user, as the querying machine learning model 26 is trained to not only determine the substance of the request, but the format that request so as to ensure accuracy.

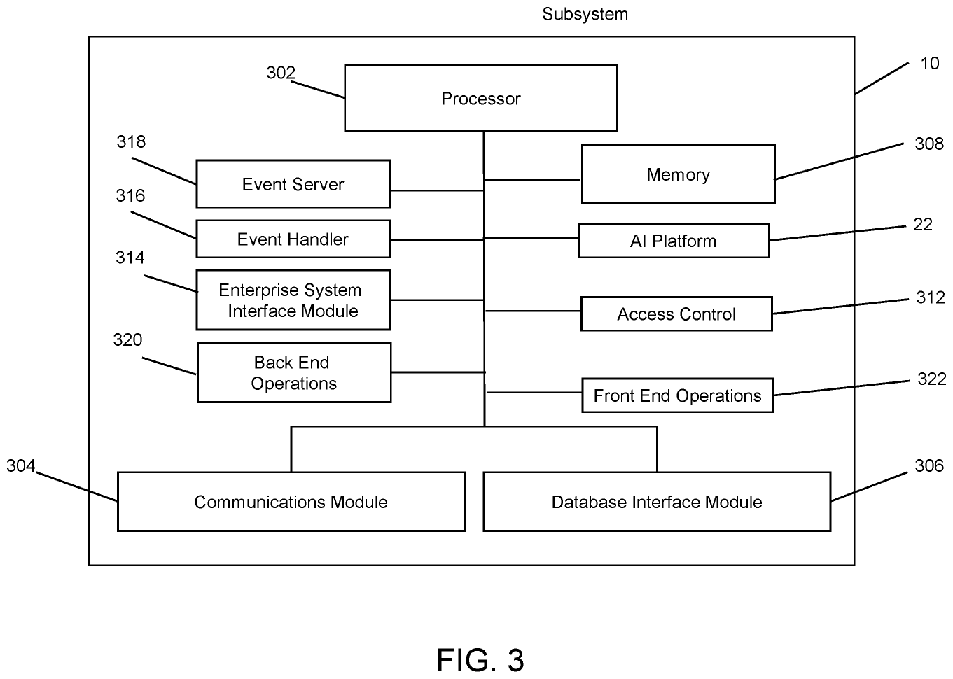

In FIG. 3, an example configuration of the platform 10 is shown. In certain embodiments, the platform 10 may include one or more processors 302, a communications module 304, and a database interface module 306 for interfacing with the different data element sources, including datastore 18, or the remote platform 20, etc. Communications module 304 enables the platform 10 to communicate with one or more other components of the computing environment 8, such as client device 12 (or one of its components), via a bus or other communication network, such as the communication network 14. The platform 10 includes at least one memory 308 or memory device that can include a tangible and non-transitory computer-readable medium having stored therein computer programs, sets of instructions, code, or data to be executed by processor 302.

FIG. 3 illustrates examples of modules, tools and engines stored in memory 308 on the platform 10 and operated by the processor 302. It can be appreciated that any of the modules, tools, and engines shown in FIG. 3 may also be hosted externally and be available to the platforms 10, e.g., via the communications module 304. As shown in FIG. 3, the platform 10, depending on the configuration, can include one or more of an access control module 312, an enterprise interface module 314, an event handler module 316, an event server 318, back-end operations module 320, front end operations module 322, and a component of the AI platform 22.

The access control module 312 can apply a hierarchy of permission levels or otherwise apply predetermined criteria to determine which data, services, programs, etc., the AI platform 22, or other systems or platforms interacting with each platform 10 receive or have access to.

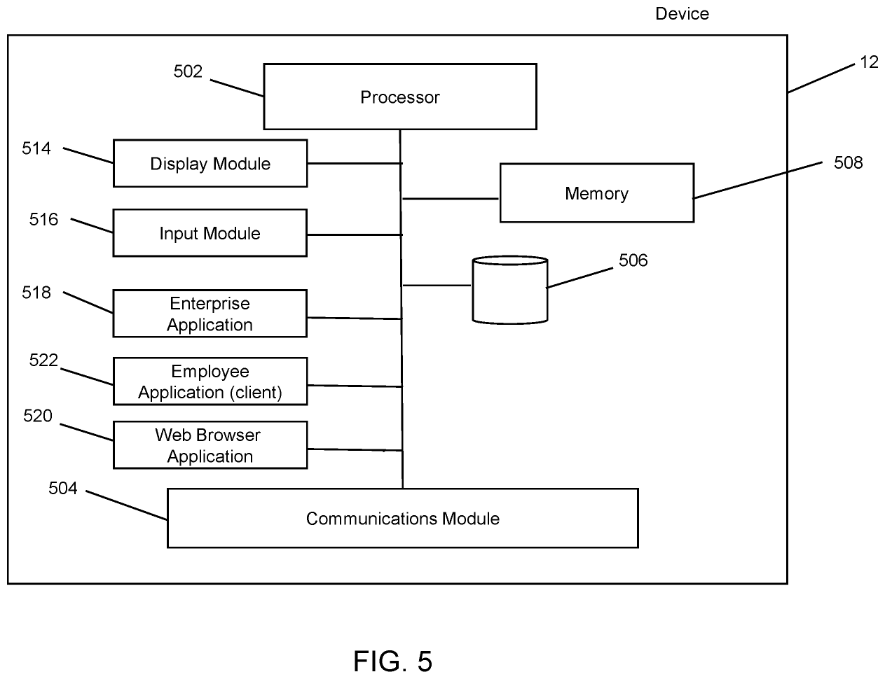

The enterprise interface module 314 can provide a GUI or API connectivity to communicate with the enterprise system 16 to obtain enterprise data for a certain user (see FIG. 5). It can be appreciated that the enterprise system interface module 314 may also provide a web browser-based interface, an application or “app” interface, a machine language interface, etc.

The event handler module 316 can be included in platforms 10 that are event handler platforms 28. The event handler module 316 can include the necessary routines to enable tracking of events, of communicating with back-end platforms 10, of interacting with machine learning models, etc.

Relatedly, the platforms 10 can include an event server 318 to store and facilitate the event handler module 316. For example, the event server 318 can be a physical server, or an API to coordinate with a remote platform 20 for storage, etc.

The platforms 10 can include either a back-end operations module 320, or a front-end operations module 322, or include both while activating one module. The back-end operations module can manage back-end systems, such as providing records of credit card applications, mortgage entitlements, etc. The back-end operations module 320 can store and maintain the definitive or reference version of any properties which a query is able to access. Similarly, the front-end operations module 322 can include one or more applications for devices 12 interacting with eh enterprise system 16 (e.g., the applications 24).

In FIG. 4, an example configuration of the enterprise system 16 is shown. The enterprise system 16 includes a communications module 402 that enables the enterprise system 16 to communicate with one or more other components of the computing environment 8, such as client device 12 (or one of its components) or platforms 10, via a bus or other communication network, such as the communication network 14. The enterprise system 16 includes at least one memory 404 or memory device that can include a tangible and non-transitory computer-readable medium having stored therein computer programs, sets of instructions, code, or data to be executed by one or more processors (not shown for clarity of illustration). FIG. 4 illustrates examples of servers and datastores/databases operable within the system 16. It can be appreciated that any of the components shown in FIG. 4 may also be hosted externally and be available to the system 16, e.g., via the communications module 402.

In the example embodiment shown in FIG. 4, the enterprise system 16 includes one or more servers 408 for managing events of an event-based tracking system, and one or more servers 406 to facilitate applications (e.g., applications 24) or machine learning models. One or more servers enable components of the enterprise system 16 (e.g., the platforms 10) to interface with other platforms.

A separate server 410 for the querying machine learning model 26 can be implemented, and a separate server can be implemented for interacting with customers or front-end employees (e.g., the shown web application server 412, or a telephony server (not shown), or a chatbot server, etc.). In the example of a web application server 412, it can support interactions using a website accessed by a web browser application 520 (see FIG. 5) running on the client device 12. It can be appreciated that the web application server 412 (or a similar server that can be used by multiple platforms 10) can provide different front endpoints for the same application, that is, the mobile (app) and web (browser) versions of the same application of the platform 10. For example, the enterprise system 16 may provide a security application (not shown) for access by different employees (or related contractors) that be accessed via a client device 12 via a dedicated application, while also being accessible via a browser on any browser-enabled device. The enterprise system 16 can include the AI platform 10, which can be maintained independent of the platforms 10, or the different models can be dispersed to the individual platform 10.

Although not shown in FIG. 4, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storages for storing and providing data for use in such services, such as datastore 18 for storing sensitive.

In FIG. 5, an example configuration of the client device 12 is shown. In certain embodiments, the client device 12 may include one or more processors 502, a communications module 504, and a datastore(s) 506, storing one or more data elements (or fragments thereof), or target properties that are to be the subject of normalization. Communications module 504 enables the client device 12 to communicate with one or more other components of the computing environment 8, such as the platforms 10 or enterprise system 16, via a bus or other communication network, such as the communication network 14. At least one memory 508 or memory device that can include a tangible and non-transitory computer-readable medium having stored therein computer programs, sets of instructions, code, or data to be executed by processor 502 can be part of device 12. FIG. 5 illustrates examples of modules and applications stored in memory on the client device 12 and operated by the processor 502. It can be appreciated that any of the modules and applications shown in FIG. 5 may also be hosted externally and be available to the client device 12, e.g., via the communications module 504.

In the example embodiment shown in FIG. 5, the client device 12 includes a display module 514 for rendering GUIs and other visual outputs on a display device such as a display screen, and an input module 516 for processing user or other inputs received at the client device 12, e.g., via a touchscreen, input button, transceiver, microphone, keyboard, etc. The client device 12 may also include an enterprise application 518 provided by the enterprise system 16, e.g., for remotely controlling the platforms 10 or related components (e.g., an employee of the enterprise system 16, etc.). The client device 12 in this example embodiment also includes a web browser application 520 for accessing Internet-based content, e.g., via a mobile or traditional website.

The datastore 506 may be used to store device data, such as, but not limited to, an IP address or a MAC address that uniquely identifies client device 12 within environment 8. The datastore 506 may also be used to store application data, such as, but not limited to, login credentials, user preferences, cryptographic data (e.g., cryptographic keys), etc.

It will be appreciated that only certain modules, applications, tools, and engines are shown in FIGS. 3 to 5 for ease of illustration and various other components would be provided and utilized by the platforms 10, enterprise system 16, and client device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in platforms 10 or enterprise system 16, or client device 12, or accessible or connectable thereto. Any application or module herein described may be implemented using computer readable/executable instructions that may be stored or otherwise held by such computer readable media.

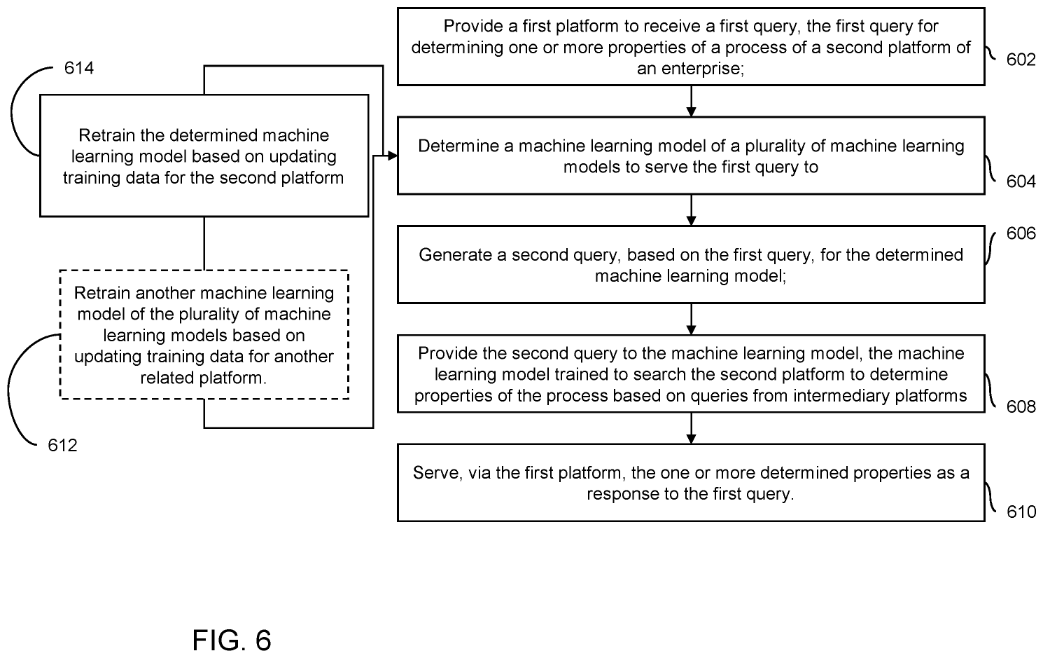

Referring now to FIG. 6, is a flow diagram of an example of computer executable instructions for coordinating resources in multiplatform environment.

At block 602, a first platform (e.g., a front-end platform 10a) to receive a first query (e.g., query 42) is provided. The first query includes a query to determine one or more properties of a process of a second platform of an enterprise. For example, the query can be for the status of an application, which status is maintained by the second platform (e.g., a back-end platform).

At block 604, a machine learning model of a plurality of machine learning models is selected based on the first query. The selected machine learning model is associated with the second platform that interfaces with the process.

At block 606, a second query is generated based on the first query. The second query (e.g., query 44) is for the selected machine learning model.

At block 608, the second query is used, with the selected machine learning model to search the second platform to determine properties of the process. The selected machine learning model is trained based on queries from intermediary platforms. The selected machine learning model outputs the one or more properties determined by the selected machine learning model.

At block 610, the one or more determined properties are served, via the first platform, as a response to the first query.

At block 612 and 614, the instructions can be for retraining the selected machine learning model (e.g., block 614), or retraining another machine learning model of the plurality of machine learning modes in the AI platform 22 based on changes to the related underlying platforms (e.g., a new application process is put in place). The ability to update machine learning models piecemeal can enable greater flexibility, for example to respond to changes to underlying platforms 10 (e.g., a new or updated workflow is used by the platform 10, with the retrained model being trained on the new or updated workflow to increase accuracy), to changes in machine learning model approaches, etc.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for coordinating resources in multiplatform environments, the device comprising:
a processor;
a communications module coupled to the processor; and
a memory coupled to the processor, the memory storing computer executable instructions that when executed by the processor cause the processor to:
provide a first platform to receive a first query, the first query for determining one or more properties of a process of a second platform of an enterprise;
select a machine learning model from a plurality of machine learning models based on the first query, the selected machine learning model being associated with the second platform that interfaces with the process;
generate a second query, based on the first query, for the selected machine learning model;
use the second query and the selected machine learning model to search the second platform to determine properties of the process and output one or more determined properties, the selected machine learning model having been trained based on queries from intermediary platforms; and
serve, via the first platform, the one or more determined properties as a response to the first query.

2. The device of claim 1, wherein the first query is provided by a user, and the intermediary platform is an automated platform for generating second queries from the user input first query.

3. The device of claim 1, wherein each of a first group of machine learning models of the plurality of machine learning modes are trained to determine properties of different platforms.

4. The device of claim 1, wherein the second platform is an event handler that manages a plurality of processes for a plurality of platforms.

5. The device of claim 4, wherein the selected machine learning model is trained to identify properties from the plurality of processes maintained by an event handler.

6. The device of claim 1, wherein the instructions cause the processor to retrain the selected machine learning model based on updating training data for the second platform.

7. The device of claim 6, wherein the instructions cause the processor to:
retrain another machine learning model of the plurality of machine learning models based on updating training data for another related platform.

8. The device of claim 1, wherein the first platform comprises a telephonic channel or a computer-based channel for receiving input from customers or employees.

9. The device of claim 8, wherein the computer-based channel is a chatbot.

10. The device of claim 1, wherein the selected machine learning model is trained with reference data representing workflows of the second platform.

11. A method for coordinating resources in multiplatform environments, the method executed by a device having a communications module and a processor, the method comprising:
providing a first platform to receive a first query, the first query for determining one or more properties of a process of a second platform of an enterprise;
selecting a machine learning model from a plurality of machine learning models based on the first query, the selected machine learning model being associated with the second platform that interfaces with the process;
generating a second query, based on the first query, for the selected machine learning model;
using the second query and the selected machine learning model to search the second platform to determine properties of the process and outputting one or more determined properties, the selected machine learning model having been trained based on queries from intermediary platforms; and
serving, via the first platform, the one or more determined properties as a response to the first query.

12. The method of claim 11, wherein the first query is provided by a user, and the intermediary platform is an automated platform for generating second queries from the user input first query.

13. The method of claim 11, wherein each of a first group of machine learning models of the plurality of machine learning modes are trained to determine properties of different platforms.

14. The method of claim 11, wherein the second platform is an event handler that manages a plurality of processes for a plurality of platforms.

15. The method of claim 14, wherein the selected machine learning model is trained to identify properties from the plurality of processes maintained by an event handler.

16. The method of claim 11, comprising retraining the selected machine learning model based on updating training data for the second platform.

17. The method of claim 16, further comprising retraining another machine learning model of the plurality of machine learning models based on updating training data for another related platform.

18. The method of claim 11, wherein the first platform comprises a telephonic channel or a computer-based channel for receiving input from customers or employees.

19. The method of claim 18, wherein the computer-based channel is a chatbot.

20. A non-transitory computer readable medium for coordinating resources in multiplatform environments, the computer readable medium comprising computer executable instructions for:
providing a first platform to receive a first query, the first query for determining one or more properties of a process of a second platform of an enterprise;
selecting a machine learning model from a plurality of machine learning models based on the first query, the selected machine learning model being associated with the second platform that interfaces with the process;
generating a second query, based on the first query, for the selected machine learning model;
using the second query and the selected machine learning model to search the second platform to determine properties of the process and outputting one or more determined properties, the selected machine learning model having been trained based on queries from intermediary platforms; and
serving, via the first platform, the one or more determined properties as a response to the first query.
